(19) United States
(12) Patent Application Publication
(10) Pub. No.: US 2010/0117258 A1
(43) Pub. Date: May 13, 2010

(54) APPARATUS AND METHOD

(75) Inventor: Roderick Francis Brazier, Hertfordshire (GB)

Correspondence Address: THE WEINTRAUB GROUP, P.L.C., 28580 Orchard Lake Road, Suite 140, Farmington Hills, MI, 48334, US

(73) Assignee: BRIGHTWATER ENGINEERING LIMITED, Hertfordshire (GB)

(21) Appl. No.: 12/311,382

(22) PCT Filed: Sep. 26, 2007
(86) PCT No.: PCT/EP2007/060222

§ 371 Date: Nov. 21, 2009

(30) Foreign Application Priority Data
Sep. 26, 2006 (GB) 0618942.7

(51) Int. Cl. B29C 47/20; B29C 47/88; D01D 5/24

(52) U.S. Cl. 264/150; 425/6; 264/209.1; 425/113

(57) ABSTRACT

A method and apparatus of production of tubes comprising, on an extruder, extruding molten plastics through die formations of a die head so as to extrude tubes each including at least one internal longitudinal web, and subsequently cooling the extruded tubes. In addition, when advancing molten plastics through a die hole (110) of the die head, the die head includes a die mandrel (122) having a first portion (124) attached to the die body and a second portion (126) extending in the die hole (110) so as to extrude the tube with at least one internal longitudinal web, the advancing including conveying molten plastics along a flow passageway (134) in the first portion (124) of the die mandrel (122) towards a central longitudinal region of the die hole at the second portion (126). The die body advantageously has a die mandrel locating device (118) arranged at the upstream side of the die body for locating the die mandrel (122) centrally of the die hole (110) of the die body. Cooling is performed by having a fluid delivering device (202) for directing cooling fluid directly on to a downstream surface of the die head to cool the extruded tubes exiting from the die formations, which are then chopped to the desired size.

This invention relates to apparatus for and a method of producing particles for inclusion in a media bed.

Compound extrusion (or compound pelletizing) machines are widely used within the plastics industry to produce pellets of thermoplastics material suitable for subsequently forming into specific shapes in moulding machines. The feedstocks for these extrusion machines may be powders, or chopped material made of either newly produced plastics material or recycled plastics material derived either from plastics processing or from used plastics products.

A typical compound extrusion machine consists of an Archimedean screw along the inside of a heated barrel. The feedstock is introduced at the low pressure end of the barrel as a solid. The feedstock progressively melts and forms into a continuous stream as it is pumped along the barrel and the melting occurs owing to heating elements on the outside of the barrel. As the temperature rises the viscosity of the plastics falls, allowing very high pressure to be developed at the outlet end of the barrel. Passage along the screw impeller inside the barrel also intensively mixes the melted plastics which allows plastics with different properties to be blended to produce a material of uniform and consistent properties. A debris filter is provided at the end of the impeller if the source material is recycled plastics. It is also common practice to vary temperature profiles along the barrel to obtain optimum homogeneity of the particular plastics mix.

At the end of the barrel the plastics melt is forced through a plate with multiple apertures forming jets of molten plastics. This perforated plate is referred to as a die head and the apertures as die holes.

The jets of molten plastics issuing from the die head are cooled and then chopped by rotating blades to form solid pellets. The jets can be chopped immediately upon issuing from the die head into a cooling bath of water where they solidify to form the pellets. This is known as ‘face cutting extrusion’ and is followed by the pellets being separated from the cooling water and often dried before being collected into drums or sacks for subsequent processing into plastics products.

One use of this process is to change washed and chopped re-cycled or reprocessed plastics into small pellets which can then be used for further extrusion or injection moulding. The pellets vary in size and shape but normally range from 2 mm to 10 mm in diameter and length.

Alternatively, the molten jets are pulled through the air by rollers which cool and solidify the jets. The solid jets or strings are then chopped by rotating blades to form the pellets. This method produces more odour than the above-mentioned underwater face cutting method and is known as ‘drawn extrusion’.

A known product, “BIOBEAD”®B is produced by the compound extrusion method and used in media beds in wastewater treatment systems. The raw materials are high density polyethylene (HDPE) and other plastics, to produce solid pellets with roughened surfaces. The pellets produced also contain various impurities found in recycled plastics. The die holes in this case are plain 2.5 mm diameter holes but, owing to the shear and strain stresses of the melt when it leaves the die holes under pressure, the diameter of the plastics leaving the die head swells to 4.5 mm diameter during cooling. This is a finished product which is not re-processed into any other shape or form.

A further known product is the “BIOBEAD”®M, produced by taking the “BIOBEAD”®B product and re-extruding it to form hollow cylinders with cruciform internal webs. This shape requires the ‘drawn extrusion’ type of machine. The double processing (compound extrusion followed by drawn extrusion) of the plastics has been necessary as drawn extrusion machines cannot handle the mix of shredded raw re-cycled feedstock materials required for the “BIOBEAD”®M products. Drawn extruders are usually shorter and smaller barreled machines than compounding extruders and they do not usually include in-line filtration as the feedstock used has previously undergone filtration.

To extrude such hollow tube-type product requires a die mandrel to be positioned centrally of the die hole. This mandrel is fitted with a vent to release the vacuum formed as the plastics tube leaves the die head. Without this vent the extruded tube would collapse and lose its hollow feature. Owing to the release of pressure as the tube leaves the die head, the material, as already mentioned, expands on its exit from the die hole. Thus the tube is pulled out of the hole continuously at a higher speed than that it which it issues from the hole. This draws down the diameter of the tube and also secures the integrity of the cruciform web by compressing it. The extruded tube is then passed through a second profiling die to stabilise the tube diameter before entering a cooling bath which is at a slight pressure and which solidifies the plastics to set the diameter before the tube is cut to length.

Compared to compound extrusion the drawn extrusion process is comparatively slow. The dies are also extremely expensive when, for example, four-pronged mandrels per tube are required for cruciform webbed tube. Venting a four-pronged mandrel so as not to create a vacuum is technically challenging. When using a mixture of plastics with impurities and different melt temperatures, the extrudate often pits and collapses during cooling. This requires time-consuming re-starts of the process that are wasteful of material and processing costs. To prevent this, the feedstock for drawn extrusion is first produced by compound extrusion, thus requiring two processing procedures.

A further problem in producing the finished particles from a compound extruder is that of swell, especially when using recycled plastics. As previously explained, when the tubular extrudate leaves a conventional drawn extrusion die head it is drawn down in a second profiling die to prevent swell. Without this operation the extrudate swells in diameter and in doing so stretches the internal webs, which thin and can even snap, creating an unacceptable product.

According to a first aspect of the present invention, there is provided a method of production of tubes comprising, on a compound extruder, extruding molten plastics through die formations of a die head so as to extrude tubes each including at least one internal longitudinal web, and cooling the extruded tubes.

According to a second aspect of the present invention, there is provided compound extrusion apparatus comprising a die head including a die formations arranged to form tubes each including at least one internal longitudinal web; and a cooling device arranged to cool the extruded tubes.

Owing to these two aspects of the present invention, the finished tubes can be produced by a system having only a single extrusion step.

In this way, manufacturing costs of the tubes can be significantly reduced and production volume of the finished particles can be significantly increased.

The cooled tubes may be chopped into pieces to form hollow particles each substantially cylindrical and each including at least one internal longitudinal web. The particles so formed are particularly suitable for use as particles of a media bed.

According to a third aspect of the present invention, there is provided a method of production of a tube, comprising advancing molten plastics through a die hole of a die head of a die body, said die head including a die mandrel having a first portion attached to said die body and a second portion extending in said die hole so as to extrude said tube with at least one internal longitudinal web, and cooling the extruded tube, said advancing including conveying molten plastics along a flow passageway in said first portion of said die mandrel towards a central longitudinal region of said die hole at said second portion.

According to a fourth aspect of the present invention, there is provided extrusion die apparatus for use in production of a tube including at least one internal longitudinal web, said apparatus including a die body, a die hole in said die body, and a die mandrel having a first portion attached to said die body and a second portion extending in said die hole so as to extrude said tube, said first portion of said die mandrel including a flow passageway arranged to guide molten plastics to a central longitudinal region of said die hole at said second portion.

Owing to these two aspects of the present invention, it is possible to deliver enough molten plastics to the core of the mandrel to form at least a substantial proportion of at least one internal longitudinal web of a tubular product such that, upon cooling of the product, the web(s) do(es) not thin to a large degree or snap.

Advantageously, the first portion of each mandrel is readily detachable from the die body.

According to a fifth aspect of the present invention, there is provided extrusion die apparatus for use in production of tubes, said apparatus including an extruder barrel, an extruder screw for advancing molten plastics towards a die head, said die head comprising a die body having a die mandrel locating device arranged at the upstream side of said die body and for locating a die mandrel centrally of a die hole of said die body.

According to a sixth aspect of the present invention, there is provided a method of production of tubes, comprising, prior to fixing a die head relative to an extruder barrel, positioning by means of a die mandrel locating device, a die mandrel longitudinally centrally of a die hole in a die body of said die head.

Owing to these two aspects of the present invention, a die mandrel can be appropriately positioned relative to a die body.

According to a seventh aspect of the present invention, there is provided extrusion die apparatus for use in production of tubes, said apparatus including a die head having die formations through which molten plastics is advanced, and a cooling fluid delivering device for directing cooling fluid directly on to a downstream surface of said die head to cool the extruded tubes exiting from said die formations at said surface.

According to an eighth aspect of the present invention, there is provided a method of production of tubes, comprising advancing molten plastics through die formations in a die head and directing cooling fluid directly on to a downstream surface of said die head where said molten tubes exit from said die formations.

Owing to these two aspects of the invention, cooling of the extruded plastics tubes can occur immediately as the tubes exit from the die head.

In this way, the time required to dismantle the mandrels from the die head for cleaning and maintenance of the die head is greatly reduced.

In order that the invention may be clearly and completely disclosed, reference will now be made by way of example, to the accompanying drawings, in which:—

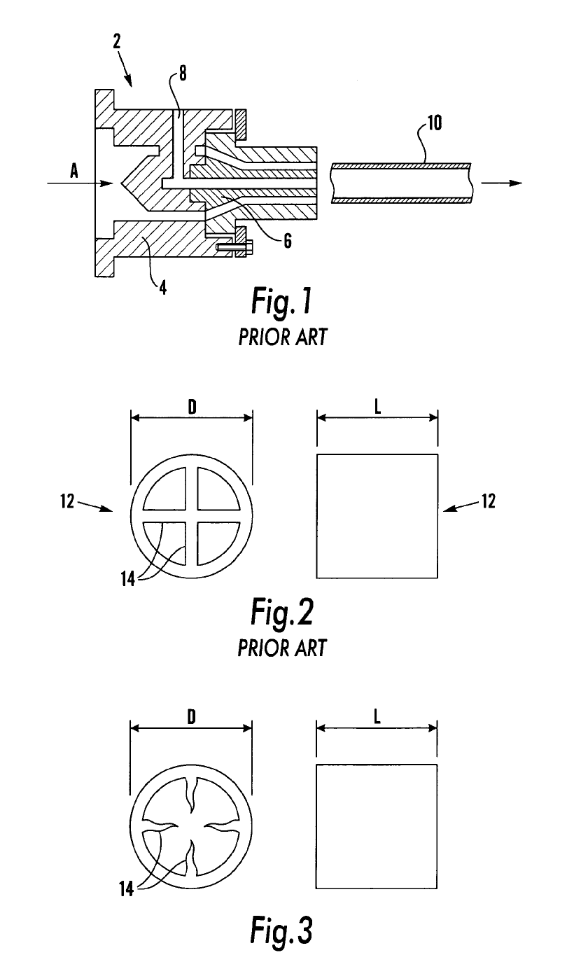

FIG. 1 shows a cross section through an annular die head of a known drawn extrusion machine;

FIG. 2 is an end and a side elevation of a known media particle to be included in a media bed;

FIG. 3 is views similar to FIG. 2, but of a faulty known media particle;

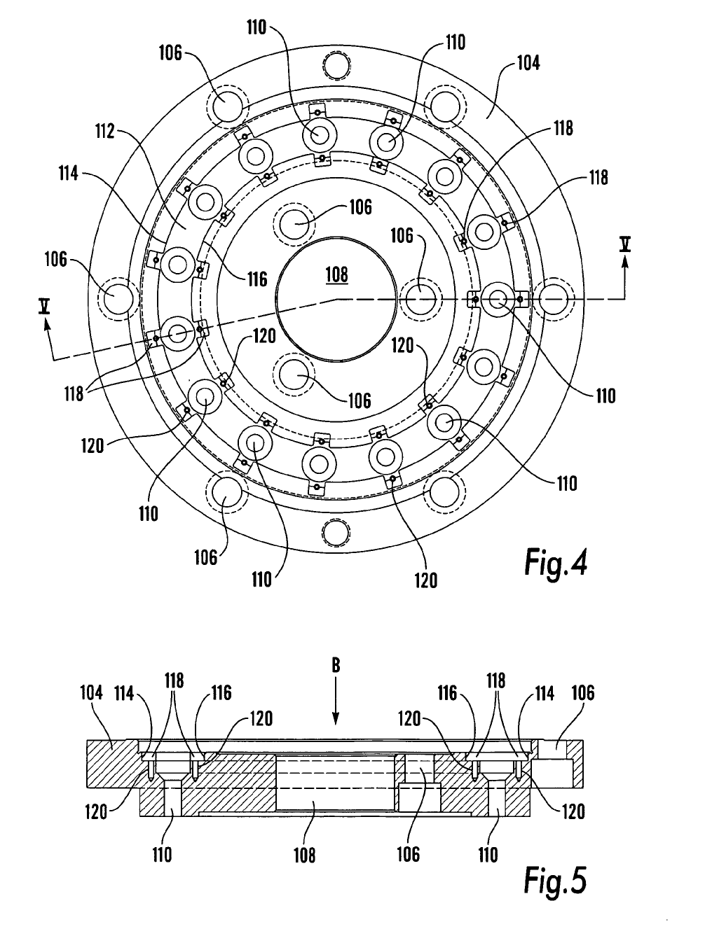

FIG. 4 is a top plan view of a die body of for a compound extruder according to an example of the invention and for forming particles of the form of FIG. 2;

FIG. 5 shows a section along the line V-V in FIG. 4;

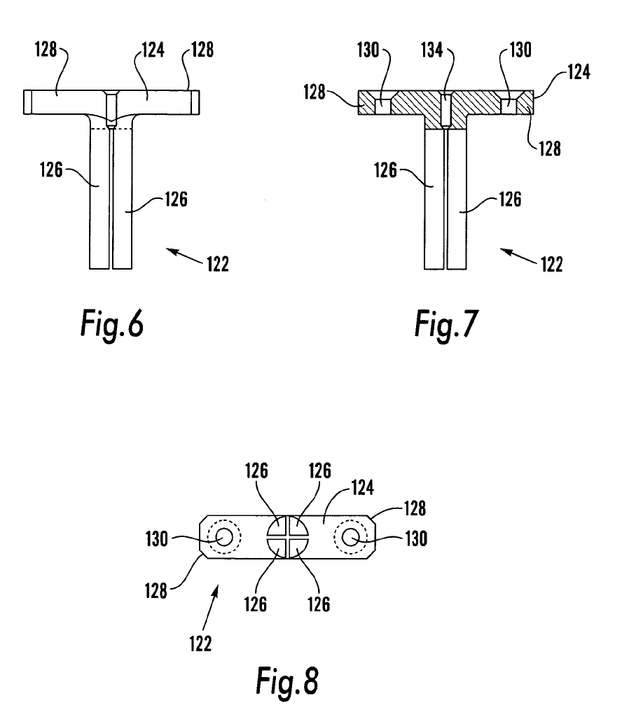

FIG. 6 is a side elevation of a slotted die hole mandrel for the die body of FIG. 4;

FIG. 7 is an axial section through the mandrel of FIG. 6;

FIG. 8 is an underneath plan view of the mandrel of FIG. 6;

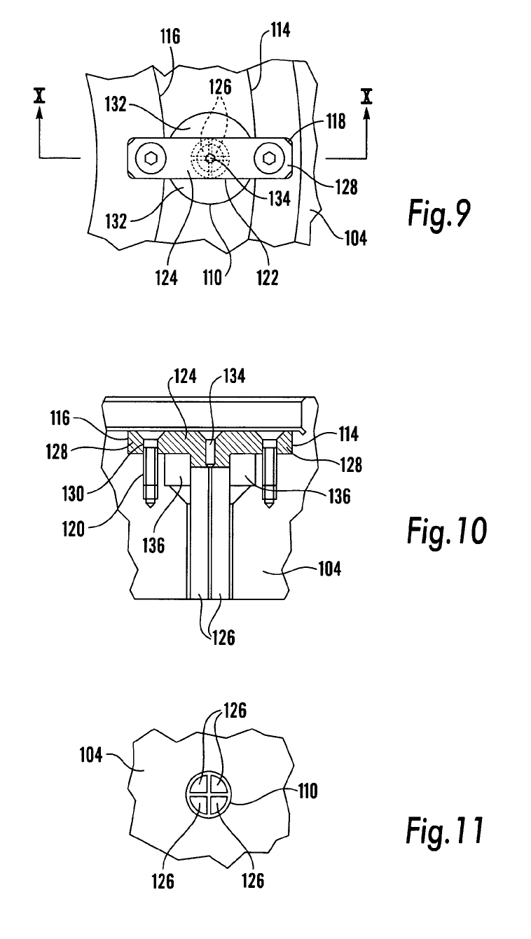

FIG. 9 is a top plan view of a part of the die body of FIG. 4 with the mandrel attached to the die body;

FIG. 10 shows a section along the line X-X in FIG. 9;

FIG. 11 is a fragmentary, underneath plan view of that part of the die body with the slotted mandrel in the die body; and

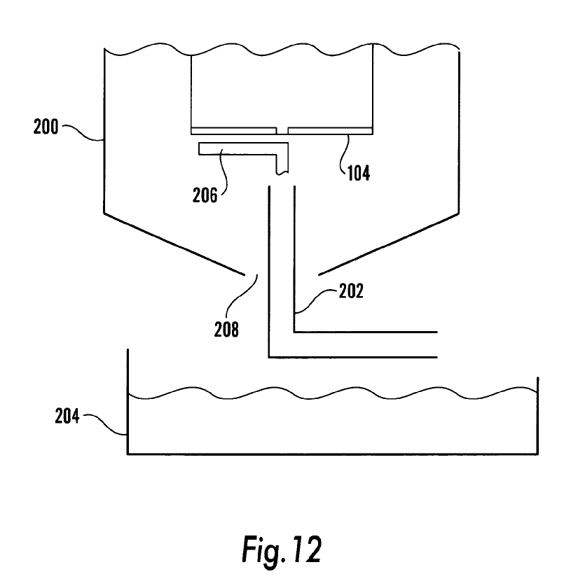

FIG. 12 is a diagrammatic representation of a cooling system for the compound extruder.

Referring to FIG. 1, a conventional die head 2 for a drawn extrusion machine comprises a die body 4 for attaching to the extruder barrel outlet (the direction of flow of molten plastics being shown by the arrow A), a die mandrel 6 having a shape to form the finished product, and an air vent 8 to prevent formation of a vacuum as the extruded plastics tube 10 leaves the die head 2.

Referring to FIG. 2, the known particle 12 is of a tubular nature and is shown as having an external diameter D and a length L and two internal diametral webs 14 which form a cruciform web structure. This construction of the particle 12 is an example of the “BIOBEAD”®M product, mentioned hereinabove.

The “BIOBEAD”®M product is produced on a drawn extrusion machine from a good quality source pellet (such as “BIOBEAD”®B), which requires, in order to overcome the problem of swell, the extruded plastics tube to be drawn down through a second profiling die in a water bath to aid in the setting of the tube diameter. The problem of the swell is such that, if no profiling die were present on the drawn extrusion machine, the tubular product would not cool quickly enough (especially internally) to prevent the plastics material from swelling to a larger diameter D and in doing so stretching the webs 14, which may snap, creating an unacceptable product, as shown in FIG. 3.

Referring to FIGS. 4 and 5, a die body 104 for a compound extruder has a plurality of through bores 106 for receiving bolts or the like for attachment to a downward outlet from the barrel of the compound extruder, a single central bore 108 for receiving the spigot of the compound extruder, and a plurality of die holes 110 (fifteen die holes being shown in this example) which are equi-spaced circumferentially around a so-called plastics flow ring 112 (which is an annular recess). The plastics flow ring 112 is bounded by outer and inner edges 114 and 116 respectively and aids in the even distribution of the molten plastics to the die holes 110. The face of the die body shown in FIG. 4 is that which faces upwardly, the direction of flow of the molten plastics through the die head being shown by the arrow B in FIG. 5.

The die body 104 also includes laterally outwardly and inwardly extending recessed portions 118 in the edges 114 and 116 respectively. Two of these recessed portions 118 are located on respective opposite inner and outer sides of the die holes 110. Each pair of recessed portions 118 forms die mandrel locating recesses and each recess is provided with a bore 120 for receiving an attaching device, such as a screw. In this way, die mandrels can easily be attached to the die body 104. Such a die mandrel 122 is shown in FIGS. 6 to 11 and has a generally T-shaped elevational profile. The upper horizontal section 124 is a fixing plate and the lower vertical section includes four elongate quarter-circle sectors 126 with a cruciform void thereamong (as shown in FIG. 8). Respective opposite end portions in the form of locating lugs 128 of the fixing plate 124 are provided with through-bores 130. The elongate sectors 126 are for inserting into the die hole 110 with the lugs 128 of the fixing plate 124 closely fitting into the recessed portions 118.

In this way, the mandrel 122 can be secured accurately in the centre of the die hole 110 by screws where the through-bores 130 align with the bores 120 for receiving the screws, or by a compressive fit, when the bores 120 and 130 can be dispensed with. The width of the fixing plate 124 is kept to a minimum so as to ensure that sufficient flow of molten plastics passes the outside edges of the mandrel 122 via semi-circular inlet spaces 132 (see FIG. 9) into the die hole 110. The free ends of the elongate sectors 126, when the mandrels 122 are fixed in position, are in the plane of the die body outlet face to ensure a clean cut by one or more rotating blades which chop the extruded plastics into the finished particles.

Each mandrel 122 also comprises a central feed passage 134 in the fixing plate 124, which, when the mandrel 122 is fixed in place, is co-axial with the die hole 110. The feed passage 134 forms a direct passageway for molten plastics to reach the voids between the elongate sectors 126 at the core of the mandrel, which plastics will form at least a significant proportion of the internal web structure of the finished particle similar to that shown in FIG. 2. In effect, the presence of the feed passage 134 creates a pressure of the molten plastics in the central void of the mandrel 122 greater than conventional, and delivers more molten plastics into the voids among the elongate sectors 126 than if the molten plastics were to enter the die hole 110 through only the inlet spaces 132. Thus, upon cooling of the extruded plastics when it leaves the die head, when swell occurs, the excess material delivered into that central void results in a higher density of material which allows for stretching of the formed webs without thinning or snapping.

It may be necessary to enlarge the diameter of die holes 110 compared to those conventionally used on a compound extruder, in order to equip it with the mandrels 122. The diameter of the die holes largely depends upon pressure, temperature and land length (i.e. thickness of the die head), but by judicial adjustment of these parameters the level of swell can be controlled sufficiently to produce an acceptable final product. The size of the feed passage 134 is determined by calculations based on operating conditions so as to improve the distribution of molten plastics as it enters the die head. The compound extrusion process can then readily be optimized by adjustment of:—
flowrate of molten plastics along the extruder barrel
temperature profile along the barrel
filtration aperture size
pressure at the die head
size of the die head.
temperature in the die head
number of cutter blades at the die head
spacing of cutter blades to produce designed length of product
die head cutter speed
level of water cooling in a die head bath to solidify the product.

The required length of the mandrel 122 is related to the size of the central feed passage 134 and is accurately calculated. The mandrel length (and thereby also the land length) dictates the stress levels, which determine the extent of swell.

The dimensions of the fixing plate 124 of the mandrel 122 are precisely calculated as are the dimensions of the feed passage 134, including the two locations along that passage where the cross-sectional area of the passage is reduced, in order to obtain the optimum flow of molten plastics into the voids among the elongate sectors 126. The length of the elongate sectors is calculated to obtain optimum laminar flow along the voids. If the length of the elongate sectors 126 and the land length of the die head are too large, the flow of molten plastics along the voids experiences excessive friction against the external surfaces of the elongate sectors and the bounding surfaces of the die holes 110, which has an effect on the degree of swell of the extruded plastics leaving the die head, resulting in an unacceptable final product.

The optimum flow of molten plastics is further promoted by the shape of the die hole 110. As can be seen from FIGS. 5 and 10, the die hole is wider at its upper end. Working progressively down the die hole 110, the bounding wall of the die hole is substantially circular cylindrical where the die hole has its largest diameter, then has a portion which is substantially frusto conical with the die hole progressively reducing in diameter, and a final portion which is substantially circular cylindrical and has the smallest diameter of the die hole. The semi-circular inlet spaces 132 (see FIG. 9) are those gaps left at the opening of the largest diameter portion of the die hole 110 when the mandrel 122 is fixed in place in the die hole. Inwardly of the secured fixing plate 124, the portion of the die hole having the largest diameter and that portion which progressively reduces in diameter form an annular void 136 about the part of the mandrel 122 where the elongate sectors 126 extend downwardly from the fixing plate 124. The volume of the annular void 136 is closely related to the width of the fixing plate 124 to obtain the optimum flow of molten plastics through the semi-circular spaces 132 and into the portion of the die hole 110 of the smallest diameter in order to surround the elongate sectors 126 and subsequently form the tubular wall of the final product.

As the extruded plastics leaves the die head in its tubular form with the internal diametral webs it has a consistency similar to that of syrup so that it is necessary, as is conventional, to cool and then chop the tubular product to form the final particles. With conventional compound extruders, the exact form of the pellets produced is not that critical since they will later be re-extruded. However, for a desired finished tubular particle with internal diametral webs to be produced on a compound extruder, the form is critical to obtain an acceptable product. Therefore, the extruded plastics leaving the die head is cooled as rapidly as possible in order to control the swell and set the desired shape. A known system of cooling requires spraying water, which is recycled, at a temperature of approximately 60° C. to be circulated within a housing surrounding the die head of a compound extruder. A problem with use of this known system in the present compound extruder would be that, whilst the outside wall of the tubular part of the extruded product would set, the internal diametral webs of the extruded product would not be cooled rapidly enough to set the desired shape, so that continued expansion would produce an unacceptable product. Referring to FIG. 12, a cooling system for the present compound extruder comprises a shielding 200, a cooling fluid spraying device 202 and a water bath 204. The shielding 200 surrounds the downward outlet from the extruder barrel and its associated cutting blade 206, and has an opening 208 where finished particles leave the compound extruder and fall into the cooling water bath 204. The finished particles are subsequently separated and dried, as is conventional. The cooling fluid spraying device 202 sprays jets of cooling fluid, preferably cold water at less than approximately 15° C., directly on to the exposed surface of the die head. Thus, rapid cooling of both the external and internal surfaces of the extruded plastics leaving the die head occurs, setting the shape of an acceptable final product to be chopped into particles.

The preferred dimensions of an acceptable final particle are between substantially 8 mm and substantially 30 mm, and most preferably between substantially 12 mm and substantially 16 mm, in diameter, between substantially 1 mm and substantially 25 mm in length, with tubular wall thickness and a thickness of the internal diametral webs of between substantially 0.5 mm and substantially 2 mm, but most preferably being substantially 0.7 mm.

An advantage of the present arrangement is when the die head of the compound extruder needs cleaning, owing to the readily removable nature of the mandrels 122 from the die holes 110, the amount of down-time, when the compound extruder is not running, is significantly reduced, therefore increasing production time.

The particles produced are particularly useful in systems for the treatment of wastewater. Advantageously, the particles, which have roughened, pitted surfaces, are used to support the growth of micro-organisms, in, for example, a Submerged Aerated Filter (SAF) system.

The cooling system illustrated in FIG. 12 is usable in any appropriate extruder, but in particular in a compound extruder.

We claim:

1-47. (canceled)

48. A method of production of tubes comprising, on a compound extruder, extruding molten plastics through die formations of a die head so as to extrude tubes each including at least one internal longitudinal web, cutting said tubes into hollow particles at a downstream surface of said die head and cooling the cut particles.

49. A method according to claim 48, wherein each of said die formations include a die mandrel having a first portion attached to said die head and a second portion extending in a die hole of said die formations, said extruding including conveying molten plastics along a flow passageway in said first portion of said die mandrel towards a central longitudinal region of said die hole at said second portion.

50. A method according to claim 49, and further comprising, prior to fixing said die head relative to an extruder barrel, positioning, by means of a die mandrel locating device, said die mandrel longitudinally centrally of said die hole.

51. A method according to claim 48, wherein said cooling comprises spraying cooling fluid directly on to said downstream surface of said die head where said tubes exit from said die formations.

52. A method according to claim 48, wherein said tubes include two internal diametral longitudinal webs forming a cruciform web structure.

53. A method according to claim 48, wherein said particles are between substantially 8 mm and substantially 30 mm in diameter, between substantially 1 mm and substantially 25 mm in length, with tubular wall thickness and a thickness of the internal diametral longitudinal webs of between substantially 0.5 mm and substantially 2 mm.

54. Compound extrusion apparatus comprising a die head including die formations arranged to form tubes each including at least one internal longitudinal web, one or more cutting blades in the region of a downstream surface of said die head for chopping the tubes into hollow particles and a cooling device arranged to cool the particles.

55. Compound extrusion apparatus according to claim 54, wherein each of said die formations include a die mandrel located in a die hole, said die mandrel having a first portion attached to said die head and a second portion extending in said die hole so as to extrude said tube, said first portion of said die mandrel including a flow passageway arranged to guide molten plastics to a central longitudinal region of the die formation at said second portion.

56. Compound extrusion apparatus according to claim 55, wherein said first portion of said die mandrel is readily detachable from said die head.

57. Compound extrusion apparatus according to claim 55, wherein said die head comprises a die body having a die mandrel locating device arranged at the upstream side of said die body and for locating said die mandrel centrally of said die hole.

58. Compound extrusion apparatus according to claim 57, wherein said die mandrel locating device includes laterally outwardly and inwardly extending recessed portions located on respective opposite inner and outer sides of the die holes.

59. Compound extrusion apparatus according to claim 55, wherein molten plastics further passes into said die formations through semi-circular inlet spaces at respective opposite lateral edges of said first portion.

60. Compound extrusion apparatus according to claim 55, wherein said die hole is widest at the upstream side of said die head where the bounding wall of the die hole defines a substantially circular cylindrical portion, followed by another portion which is substantially frusto conical progressively reducing in diameter towards the downstream side of said die head, and a further portion which is substantially circular cylindrical and having the smallest diameter of the die hole at the downstream side of said die head.

61. Compound extrusion apparatus according to claim 54, and for producing said particles which are between substantially 8 mm and substantially 30 mm in diameter, between substantially 1 mm and substantially 25 mm in length, with tubular wall thickness and a thickness of the internal diametral webs of between substantially 0.5 mm and substantially 2 mm.

62. Compound extrusion apparatus according to claim 54, wherein said particles produced are for use in systems for the treatment of wastewater.

63. A method of production of a tube, comprising, on a compound extruder, advancing molten plastics through a die hole of a die head of a die body, said die head including a die mandrel having a first portion attached to said die body and a second portion extending in said die hole so as to extrude said tube with at least one internal longitudinal web, and cooling the extruded tube, said advancing including conveying molten plastics along a flow passageway in said first portion of said die mandrel towards a central longitudinal region of said die hole at said second portion.

64. A method according to claim 63, and further comprising, prior to fixing said die head relative to an extruder barrel, positioning by means of a die mandrel locating device, said die mandrel longitudinally centrally of said die hole.

65. Compound extrusion die apparatus for use in production of a tube including at least one internal longitudinal web, said apparatus including a die body, a die hole in said die body, and a die mandrel having a first portion attached to said die body and a second portion extending in said die hole so as to extrude said tube, said first portion of said die mandrel including a flow passageway arranged to guide molten plastics to a central longitudinal region of said die hole at said second portion.

66. Compound extrusion die apparatus according to claim 65, wherein said die body includes a die mandrel locating device arranged at the upstream side of said die body and for locating said die mandrel centrally of said die hole.
